(19) United States
(12) Patent Application Publication
(10) Pub. No.: US 2003/0135400 A1
(43) Pub. Date: Jul. 17, 2003

(54) Geographically or temporally distributed simulation system

(76) Inventor: Klas Mellander, Malmo (SE)

Correspondence Address: David D Stein, Boyle Fredrickson Newholm Stein & Gratz, Suite 1030, 250 E Wisconsin Avenue, Milwaukee, WI, 53202, US

(21) Appl. No.: 10/182,039

(22) PCT Filed: Jan. 18, 2001
(86) PCT No.: PCT/SE01/00086

(51) Int. Cl. G06F 17/60; G06G 7/48

(52) U.S. Cl. 705/7; 703/6

(57) ABSTRACT

A system, a method and a computer program product for performing a geographically or temporally distributed simulation of a process, e.g. a business process, involving a simulation subject, e.g. a company and a resource used by the simulation object. The simulator (115) comprise a simulation control unit (114), a user interface (116), a simulation subject control unit (120), a resource control unit (122) and a decision handler (136). A first user team using a simulation unit makes decisions and updates simulation parameters that are distributed to other simulators participating in the simulation of a process involving a plurality of parties.

### TECHNICAL FIELD

The present invention relates generally to a technical support system for geographically or temporally distributed simulation of a process, e.g. a business process.

### BACKGROUND

In order to provide an understanding of business processes to a large number of people, there has evolved a need for tools for conducting simulations of such processes that allow for a large number of participants. Such simulations have traditionally been run in sessions with a large number of participants being divided into smaller groups under the guidance of a fewer amount of sessions leaders. The working material has typically been in the form of a model comprising a board, cards representing and characterising different kinds of resources, and some kind of value carrier representing monetary values. The simulation sessions of this kind is often relatively time consuming and can last from for example half a day to perhaps three days in order to visualise a moderately complex business process.

Problems in prior art is thus related to the time consumption and the difficulty of gathering a large number of people to one and the same location. There are also pedagogical aspects to prior art simulation, since much of the process of gaining knowledge in this field is in fact concerned with creating short cuts to long experience. Such short cuts typically arise as the participants suddenly realises causes and consequences of specific situations. The mental process involved demands a certain speed which is not always possible in prior art simulation schemes.

### OBJECT OF THE INVENTION

It is thus a general object of the present invention to provide a technical support system for conducting simulations of processes in a manner which is efficient in pedagogical respects as well as with regard to the time and location issue.

It is a more specific object of the present invention to provide a technical platform for distributed however synchronised simulation.

It is a further object to provide a computer implemented method for simulating a business process dealing with competition and the planning of available resources, e.g. in terms of working force or monetary funds, as well as with the consequences of decisions and strategies and their impact on selected business parameters.

### SUMMARY OF THE INVENTION

The object is achieved by means of a computer implemented system comprising a number of simulation units, each simulator serving a team of human users. The simulators are connectable in a network for transfer of information and parameter values preferably via a specifically dedicated server. In such a configuration, the simulation units are set up as client applications in a client/server architecture. Each simulator comprises a simulation control unit adapted to control and execute steps of a simulation as specified in predetermined rules and controlled by a simulation scheme control unit operating or in accordance with a predetermined simulation scheme. The simulator also comprises a user interface for presentation of information and input of simulation parameter values or commands by a human user. The simulator further comprises a simulation subject control unit adapted to control the behaviour or properties of a subject of a simulation process carried out in response to decisions of the user usually expressed in the form of updated simulation parameter values. The simulator further comprises a decision handler for communicating updated parameter values between the simulation control units of different simulators via a data communications equipment and a server.

In one advantageous embodiment of the invention which is specifically adapted for the simulation of a business process, each simulator comprises a simulation motor coupled to a simulation scheme control unit, and running different control units for simulating:

a simulation subject in the shape of a simulation subject entity, e.g. a company;

a resource entity e.g. people, in several instances;

a simulation object control unit in the shape of a simulation object entity, upon which the simulation subject acts or operates, e.g. clients on which the simulated business operates, in several instances;

a resource source e.g. in the shape of a market for the resource entity, e.g. people and for the simulation object entity, e.g. clients.

In a distributed simulation where several teams are operating, the markets for resource entities and simulation object entities are shared. Parameters are updated as a consequence of, as in this example, business decisions, and parameter values are at predetermined points in time transferred to the simulators serving each team. Parameter values are typically indicated by symbols or calculated into e.g. monetary units e.g. indicated in M (millions of monetary units).

One embodiment of the invention is provided with an auto pilot in the shape of an automatic decision control unit for simulating a team running a simulation subject entity. The parameters are updated and transferred to the simulation control units in a manner similar to that of a distributed simulation so that the users perceive the auto pilot as one or several other teams of users.

One aspect of the invention is particularly directed to the simulation of a business process, an organisational process or a pedagogical process simulated in interaction with human users.

The inventive concept comprises a method, a system of computer hardware and software components, a computer program product and an apparatus set up according to the invention.

### BRIEF DESCRIPTION OF THE DRAWINGS

The invention will be further described with reference to the accompanying drawings, wherein it is shown in:

FIG. 1A an overview of the inventive system comprising a number of simulators connected via a server, each simulator serving a team of participants;

FIG. 1B a schematic overview of the functional components of a simulator in accordance with the inventive concept;

FIG. 2 a functional block diagram of the functional parts of an embodiment of the simulation system;

FIG. 3 a first embodiment of the user interface in one phase of the simulation; and

FIG. 4 and 5 embodiments of the user interface in different phases of the simulation.

FIG. 6A and 6B flow charts describing embodiments of the invention.

### DETAILED DESCRIPTION OF EMBODIMENT

The invention is in a first embodiment realised as a computer program product executable on a standard computer comprising a processor, data storage memory and data input/output interfaces such as a keyboard, a display screen and data communications equipment. One or more computers set up with the inventive program or computer program product constitutes a system in accordance with the in accordance with the invention.

General Setting

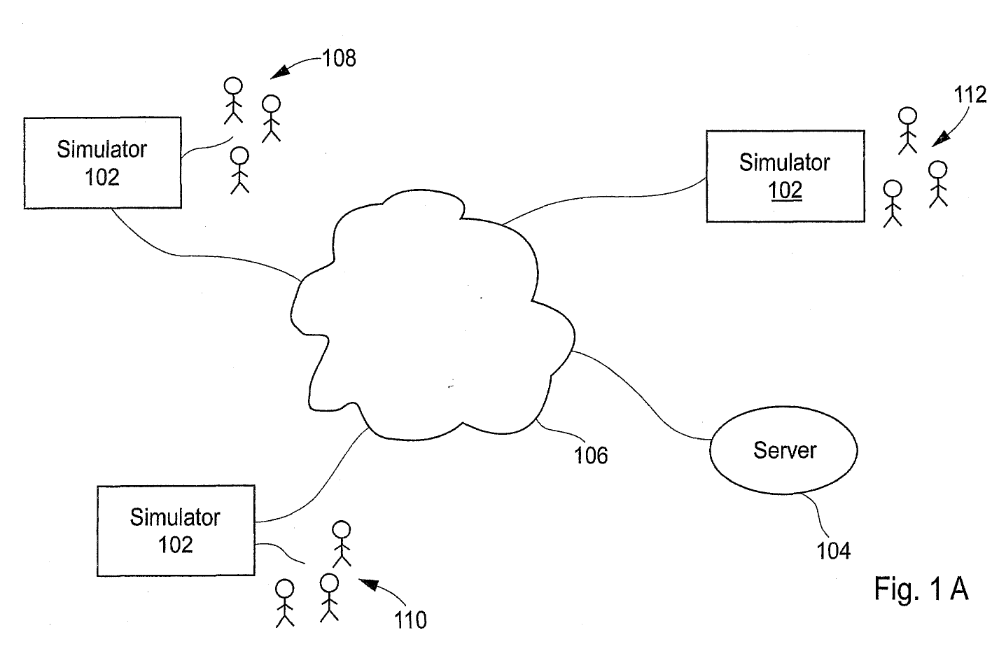

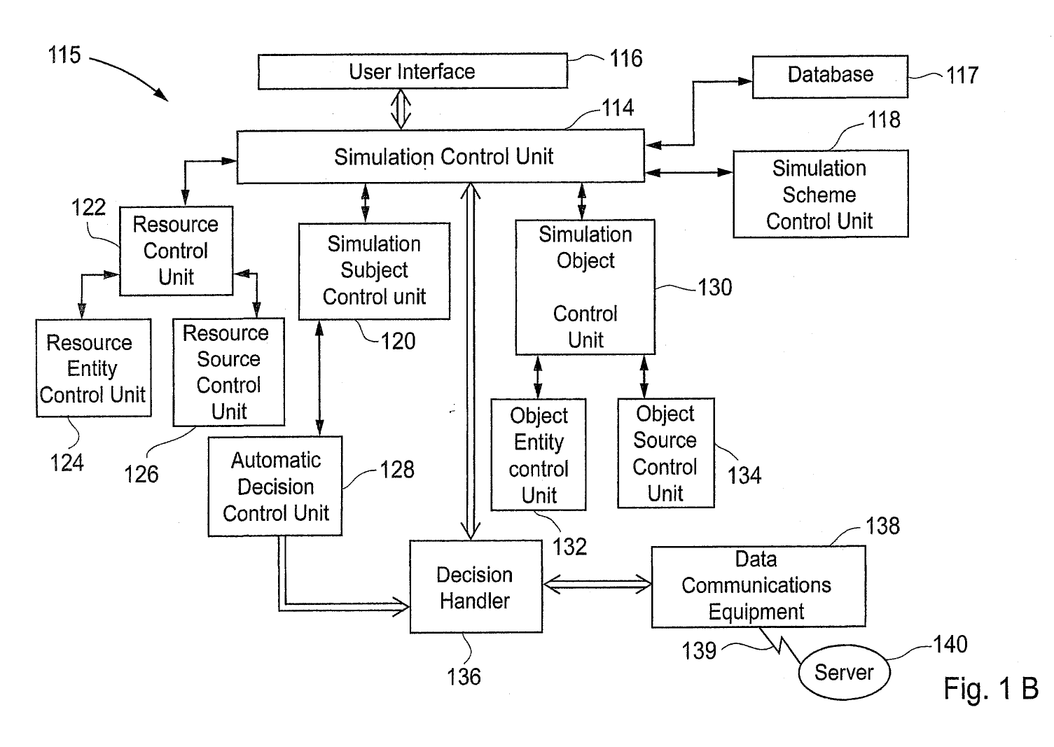

FIG. 1A shows the configuration of the invention in operation. In FIG. 1A is shown a number of simulation units 102, each thus comprising a computer set up to operate in accordance with the inventive concept by means of a computer program product, a server 104 and a data communications network 106 being capable of communicating data directly between the simulation units 102 or, as in a preferred embodiment, via the server 104. Each simulation unit 102 serves a team 108, 110, 112 of simulation participants. In one embodiment, each team runs a first phase of the simulation locally with their simulator and with respect to the information and parameter values available at that location at that time. When the team is ready with its decisions, actions and parameter updating, their simulator sends information to the other simulators preferably via the server 104, and when all teams have sent their information it is possible to start the next phase of the simulation involving new decisions and new updating of parameters. The simulation described in this text as an exemplifying embodiment of the inventive concept is concerned with a simulation subject in the shape of a business producing services carried out by resource entities in the shape of People and sold to simulation objects in the shape of Clients. It is however also conceivable to adapt the simulation to other kinds of enterprises or processes, for example a doctor diagnosing and treating a patient, a teacher applying pedagogical methods on pupils, a machine or a factory.

Typically, the invention is applied in circumstances having between for example 2 and 4 physically and/or temporally separated teams per simulation, for example 2-4 teams each running a competing process entity. There may be a plurality of parallel groups of for example 2-4 teams served by the same server. However, one embodiment is provided with an automatic decision control unit for running a simulation session locally against other teams run by an automatic team simulator, here called automatic decision control unit or autopilot.

Functional Components

FIG. 1B shows the general functional components comprised in each simulation unit (102), i.e. typically the components of the computer program product. A user interface 116 for the presentation of information to the user as well as input of decisions for the simulated process, usually in the form of parameter updates, is communicatively coupled to a simulation control unit 114 for controlling the steps of the simulation. The simulation control unit comprises or is communicatively coupled to a simulation scheme control unit 118 controlling the simulation steps and a database 117 for storing information and parameter values. The simulation control unit and/or the simulation scheme control unit is provided with or has access to predetermined rules or a predetermined simulation scheme.

Furthermore, a simulation subject control unit 120 being communicatively coupled to the simulation control unit 114 and being devised for controlling the subject or entity of the simulated process, i.e. the subject, on which the simulation is carried out, for example a company or a doctor. The simulated subject depends on some kind of resource governed by a resource control unit 122 possibly comprising or being divided into resource entity control units 124 in a plurality of instances for controlling each resource entity, e.g. people or different treatment schemes having different properties, and a resource source control unit 126 for controlling the availability of the resources at a source, e.g. a people market or a medicament supply.

In embodiments where the simulation subject acts on one or more simulation objects or factors, e.g. where a company acts on clients that are internal or external to the company, the invention comprises a simulation object control unit 130 for controlling entities of such external or internal simulation factors. The simulation object control unit 130 comprises or may be divided into object entity control units 132 in a plurality of instances, e.g. clients or patients, and an object source control unit 134 for controlling the availability of the objects at a source, e.g. a client market or a patient at a clinic.

Furthermore, a decision handler unit 136 is intermediately coupled between the simulation control unit 114 and data communications equipment 138, which is capable of transferring and receiving data to and from a server 140 via a data communications network 139. The decision handler unit 136 communicates messages and updated parameter values between simulation control units of different simulators. In general, the simulation session starts with the current parameter values and ends with a transmission of updated parameters and decisions from each team of users to the simulators of the other teams.

Each of the control units are provided with predetermined rules or schemes for the behaviour of the entity, object, subject, source, resource involved the simulation dependent on different parameters and parameter values. In the drawings, the lines drawn between different functional components indicates that the components are communicatively coupled, physically or by exchanging parameter values. This applies to the control units and components described anywhere in this description.

To be able to run a simulation independently of a network and of other human users, an embodiment of the simulator is further provided with means for simulating other teams. That is, instances of simulation subjects, objects and resources are established and are each run by an automatic decision controller unit 128, comprising decision rules for example in the shape of a kind of artificial intelligence set up to simulate teams in another layer of the simulation system. The automatically run simulation objects send their parameters and decisions to the simulation control unit via the decision handler 136. Therefore, the simulation control unit as well as the human user team perceives the automatically run teams in the same manner as other distributed teams via network communication. The difference is of course that decisions and parameter updating are generated automatically dependent on predetermined rules.

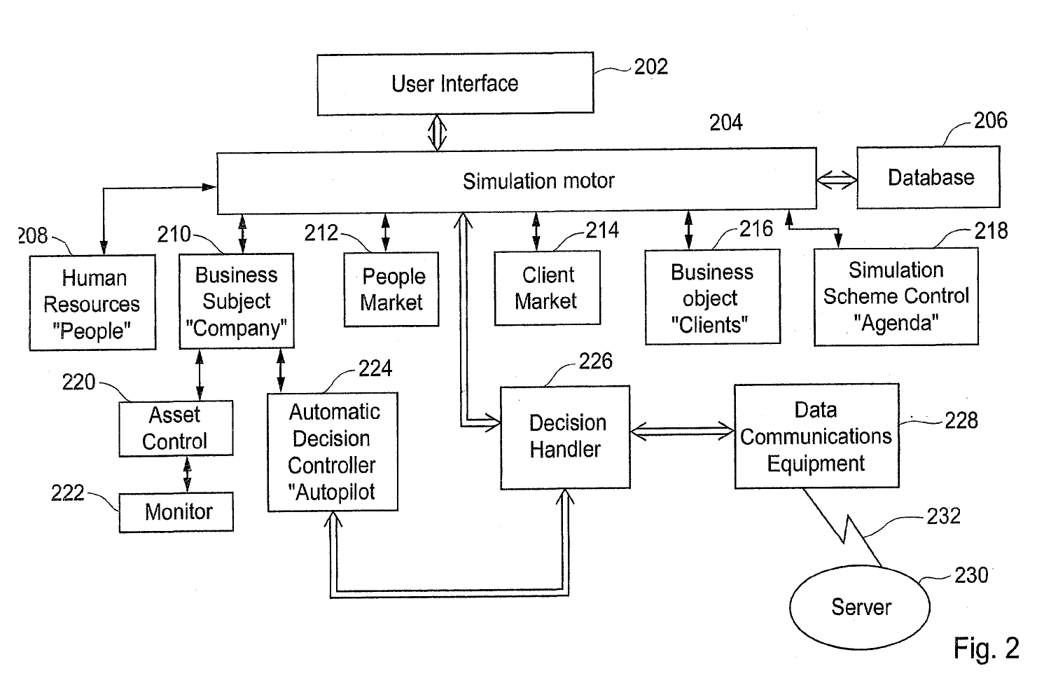

FIG. 2 shows the functional components comprised in each simulator of a more specific embodiment of the invention adapted for the simulation of a business process concerned with the production of services. More specifically, there is a user interface 202 for maintaining an input/output interface with the human users, a Simulation Motor 204 for controlling and executing the steps of the simulation and a database 206 for storing information such as variable names and parameter values needed by the different components. Furthermore, there are a number of control units for different functions, such as a Business Entity Control Unit called Company 210 which controls entities corresponding to simulation subjects in the shape of companies. The Company is in this embodiment of the invention the subject of the simulation process itself and the entity ruled by the teams. That is, each team runs an instance of the Company and makes decisions based on current business parameters thereby creating new situations and updated parameters. The consequences with regard to assets of different kinds, e.g. in monetary terms or in soft value terms, is for each company controlled by an Asset Control Unit 220, e.g. for economy control. Some embodiments also comprise an Asset Monitor Control Unit 222, coupled to the Asset Control Unit 220, which controls the calculation and presentation of predetermined, more or less complex parameters, such as key indicators for monetary or intellectual assets.

Another important functional component in this embodiment of the invention is a Human Resources Control Unit 208, here called People, which controls entities corresponding to people used as a production resource in the described simulation. Similarly there is a Business Object Control Unit 216, here called “Clients”, which controls the entities corresponding to clients of the Companies in the simulation. The people and the clients are available to the companies on markets governed by a People Market Control Unit 212 and a Client Market Control Unit 214, respectively. The simulation steps is controlled by means of a Simulation Scheme Control Unit 218, here called “Agenda”. So, the agenda specifies and presents to the teams the steps to be taken, the decisions to be made and the parameters to update during the simulation process. The above components are all communicatively coupled to the Simulation Motor 204 and the Database 206.

Furthermore, a Decision Handler Unit 226 is intermediately coupled between the Simulation Motor 204 and Data Communications Equipment 228, which is capable of transferring and receiving data to and from a server 230 via a data communications network 232. The Decision Handler 226 communicates messages and updated parameter values between simulation motors of different simulators.

To be able to run a simulation independently of a network and of other human users, an embodiment of the simulator is further provided with means for simulating other teams. That is, instances of companies are established and are each run by an Automatic Decision Controller Unit 224, here also called “Autopilot” as explained above comprising a kind of artificial intelligence set up to simulate teams in another layer of the simulation system. The automatically run companies send their parameters and decisions to the Simulation Motor via the Decision Handler 226.

Simulation Scheme

In a general embodiment the inventive method is performed in a system according to the invention and having a first and a second simulation unit being communicatively coupled in a data communications network, possibly or preferably via a simulation server. The first and second simulation units may be physically the same unit used by different users at different times, i.e. temporally distributed in a time sharing scheme. In an overall view, the method comprises the steps of:

at the first and second simulation units, performing a first simulation phase including a first set of simulation steps based on a first current status dependent on a first set of simulation parameter values and thereby generating updated parameter values;

from each of said first and second simulation unit sending updated parameter values to the other simulation unit, in other words sending parameter values updated by the first simulation unit to the second simulation unit, and parameter values updated by the second simulation unit to the first simulation unit;

at the first and second simulation units, calculating a second current status dependent on said updated parameter values;

at the first and second simulation units, performing a second simulation phase including a second set of simulation sets based on said second current status dependent on said updated parameter values.

The updated parameters are sent internally if the same physical apparatus is used to run the first and the second simulation unit, or directly between the two units but perhaps in most realisations to the simulation server via the data communications network. In the latter embodiment, the parameter values are then sent from the simulation server as mentioned above by sending parameter values updated by the first simulation unit to the second simulation unit, and parameter values updated by the second simulation unit to the first simulation unit.

In a more specific embodiment of the invention is adapted for the simulation of a business as exemplified in conjunction with FIG. 2. The simulation scheme is such that a team at one simulation site, the team typically consisting of one to five participants is posed with the problem of running a simulation subject in the shape of a company, for example called Alpha. The company is in this example engaged in the production of services and has assignments from simulation objects, here business objects, in the shape of different clients. The assignments are completed by a resource in the shape of human resources, i.e. people currently employed at the company. The company Alpha has a number of competitors, e.g. three other simulation objects in shape of companies here called Beta, Gamma and Delta. The competitors compete for the same clients and the same people that are available on an object source in the shape of a client market and a resource source in the shape of a people market, respectively. The companies, the client market and the people market are represented in the visual interface with extendable fields comprising information fields and command fields. In a distributed simulation, the different teams are provided with information about the own company, the competing companies and the common markets, i.e. the client and people markets.

The task of each team is to build the business of its company by creating value, not only values of tangible assets, e.g. equity, but also values of intangible assets e.g. calculated in monetary terms. In this embodiment, the intangible assets selected to pursue are image, structure and competence. The image value of a company is based on the image of the different clients of the company and can be influenced by the performance of the company. That is, each client on the client market is assigned an image value expressed in monetary terms and the company earns its image value from its current clients. The structure value is derived from the tools and processes the company has developed and the competence value is the total of the employed people's competence values. The values of the selected intangible assets are calculated into monetary terms in accordance with a predetermined scheme. The values of the tangible and intangible assets are summed up in a total market value.

When running the simulation, the user team running each company decides what clients to pitch for and what people to try to recruit. The clients are presented on the client market together with a number of parameters, such as maximum price the client is willing to pay for an assignment, competence requirements of people working with the assignment and preferences in the structure of the company delivering services. The people available at the people market are presented in a similar way in order for the simulated company to be able to match parameters of clients with people planned to serve the clients. These parameters are further presented below in connection with a description of the visual interface.

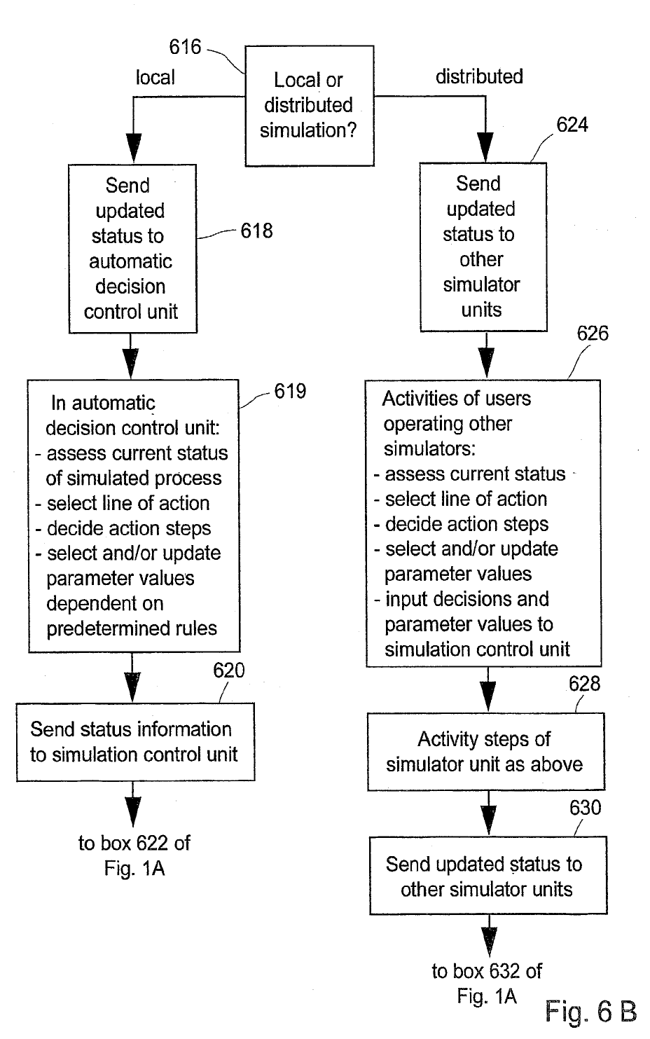

FIG. 6A and B shows a flow chart of an embodiment of the invention, comprising the following steps:

Step 601 starting a computer program comprising means for performing the following steps;

Step 602 selecting a local or distributed simulation and inputting the corresponding command to the program;

Step 604 establishing instances of simulation objects;

Step 606 retrieving start parameters and start information from a data base;

Step 608 establishing a start status of simulation entities and simulation situation dependent on predetermined parameter values;

Step 610 user activities comprising accessing current status of simulating process, selecting line of action, deciding action steps, selecting and/or updating parameter values, inputting decisions and parameter values to simulation control unit;

Step 612 receiving decision information and updated parameter values from the user via the visual interface;

Step 614 calculating and updating status dependent on decision information and parameter values;

Step 616 dependent on

Visual Interface

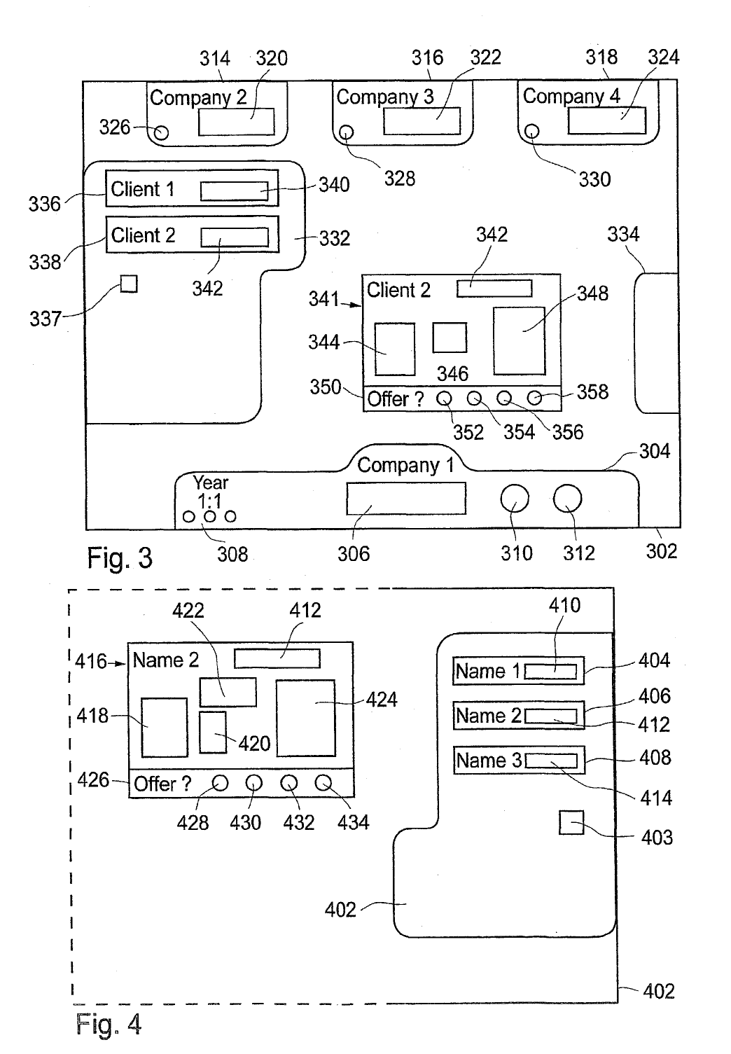

FIG. 3 shows an embodiment of the visual interface between the simulation control unit and the human users, typically realised as a graphic presentation on a display screen. The depicted interface shows in the lower part of the screen a field representing the business entity 304, in this example Company 1, run by the team using the current interface. In the upper part of the screen is shown fields representing the other business entities that are part of this particular simulation, i.e. reference numeral 314 for Company 2, 316 for Company 3 and 318 for Company 4. Each Company field comprises a characteristic field 306, 320, 322 and 324, respectively, where the characteristics of each company are indicated. In one embodiment of the invention these characteristics are Image, Structure and Competence, and for each company there is an indication of how the company is ranked with regard to each of these characteristics or criteria, for example first, second, third or fourth. The Company 1, which is the company run by the user team subjected to the shown interface, may also be provided with command fields for inputting specific commands with regard to the simulation process, for showing information 310 or for calling up a quick index 312 or the like. Typically, the inputting of commands is structured in several layers, so that a first command actuates the presentation of further command fields on the screen. The Company 1 field 304 is also provided with period indicators 308 for indicating the current account periods. The competing Company fields 314, 316, 318, that is the fields representing competing companies run by other human user teams or being simulated are provided with decision indicators 326, 328 and 330, respectively, devised to indicate the fact that the current simulator has received updated parameter values from the other teams. Preferably an indicator, e.g. a changed colour of a field is presented as soon as the respective other team (Company) has sent its decisions and parameter updates.

In FIG. 3 there are also fields representing the Client Market 332 and the People Market 334. In FIG. 3, the Client Market is magnified, which typically is commanded with an indication with a cursor function on the field in question. It is shown that the Client Market currently holds two clients, i.e. Client 1 indicated 336 and Client 2 indicated 338 available on the market to a pitching cost indicated in the cost field 337. Each client is provided with fields for characterising parameters such as monetary client value, and general preferences e.g. with regard to image, competence or structure.

The characteristics of Client 2 is in the shown interface instance highlighted in field 341, where it is indicated in the field 342 such parameters as maximum price the client is willing to pay for the assignment, chemistry of the client's team characterised by symbols, e.g. triangles, squares or circles, and required competence provided by the service delivering company as characterised by competence level indicators e.g. in the form of bars. So, for example the maximum price may be 26 M, the chemistry may be characterised by a triangle and the required competence level may be two people with minimum competence levels of 3 and 1, respectively.

Different clients have different preferences when choosing which company to work with. Such specific preferences are presented in a ranked order, e.g. competence, structure, price, image and culture. For example, a client giving competence the highest priority prefers to work with the company having the highest competence value.

Values with respect to different kinds of intangible assets in monetary terms given to a Company who obtains the Client in question is indicated in field 346, e.g. Image value amounting to 5 Million monetary units. Further client information, such as “This company looks for the best option” is indicated in field 348. Command fields for pitching offers that Company 1 can give are provided in the pitching command field 350, wherein field 352 indicates no offer, and fields 354, 356, 358 indicates pitching offers to different monetary amounts such as 20, 18 or 16 M. So, when pitching for a client the team indicates, e.g. by means of a cursor functionality an offered amount equal to the price that will be charged the client each year.

In FIG. 4 a similar presentation of the People Market 402 (334 in FIG. 3) is highlighted. In the shown example, the People market currently holds three persons, Name 1 indicated 404, Name 2 indicated 406 and Name 3 indicated 408, available to the Companies to a recruiting cost indicated in recruiting cost field 403. The characteristic parameters of the people e.g. with regard to chemistry, salary costs and competence indicated in the people characteristics fields 410, 412, 414. So, for example the chemistry may be indicated with a circle symbol, the required salary may be 3M and the current competence level may be level 1 indicated by one filled bar and two unfilled bars, where the maximum competence level in that case would be 3 and the unfilled bars would indicate the growth potential of the current person. Further highlighted is the description of person Name 2 in field 416 as a picture magnified through a command via cursor function. In the person description of field 416, the preferences of the person e.g. with regard to image, competence, salary, structure and culture are indicated in a ranked list in field 418. For example, a person giving image the highest priority prefers working with the company having the highest image value.

Values of intangible assets in monetary terms conferred to the company that recruits the person is indicated in field 420, e.g. competence to a value of 1.2M and potential competence value of 3.5M. Further characteristics are shown in the field 422, e.g. High Flyer, Medium Flyer, Demanding and Innovative, where for example an innovative person will generate ideas for new tools and processes. Further characteristics such as what the person is up to is presented in field 424 e.g. “Looks for the best option” or “will leave the? at the end of this year”. Similarly to the Client characteristic, command fields for indicating an offer for a salary per year is shown in fields 426, 428, 430, 430 and 434 for indicating no offer or offers e.g. to different monetary amounts such as 3, 4 or 5 M. So, when recruiting a person the team indicates, e.g. by means of a cursor functionality an offered amount equal to the offered salary per year.

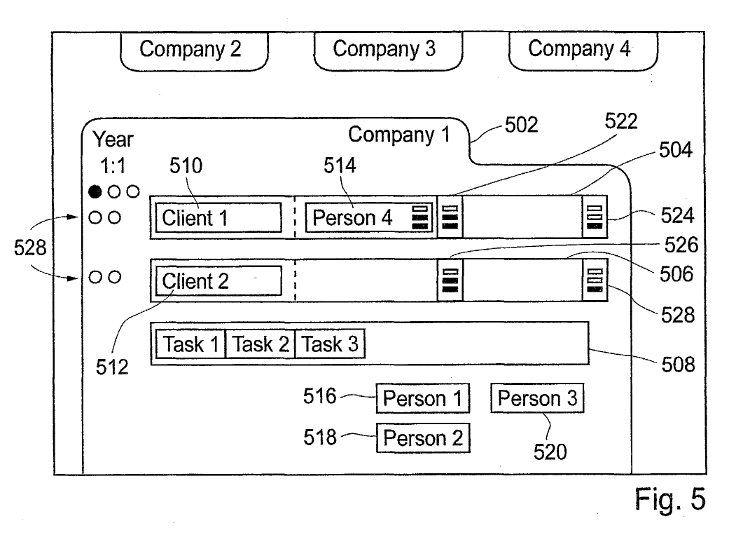

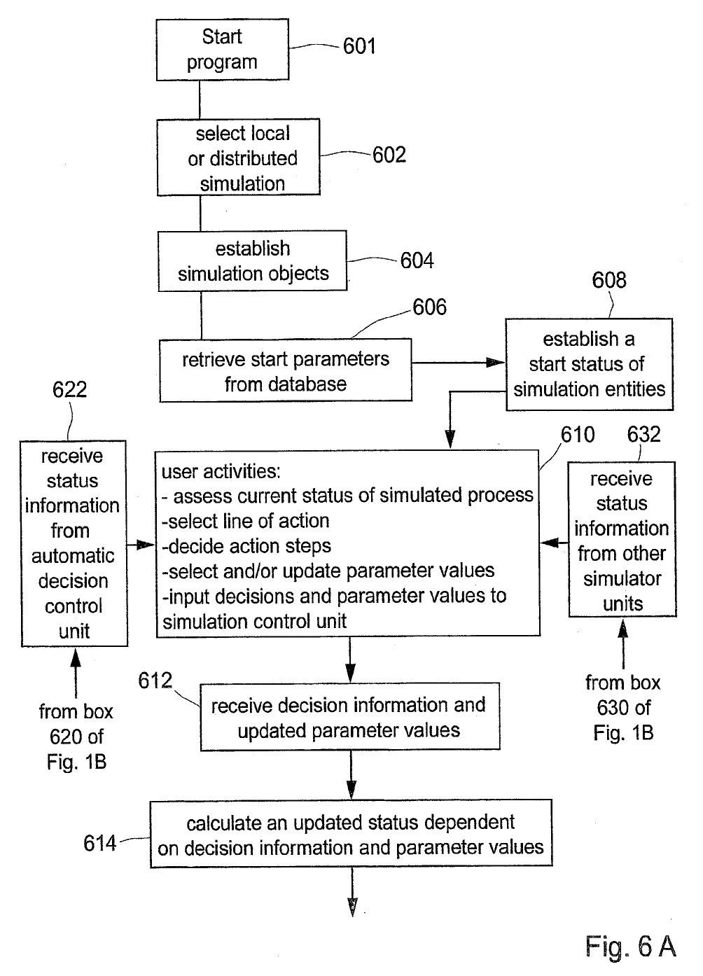

FIG. 5 shows an embodiment of an operation planning interface of the Company 1 indicated 502 comprising operation fields 504, 506 and 508 for planning the operations by assigning the people currently employed by the company to different jobs for clients. Clients are symbolised by possibly movable client fields 510, 512 and persons are symbolised by movable person fields 514, 516, 518, 520 as described in connection with FIG. 3 and 4 above. Characterising parameters are indicated in the client and person fields respectively. When planning the operations, the clients are positioned in a respective operation field 504 and 506, in this example Client 1 and Client 2. The team decides which people should be assigned to the clients and moves the people fields to the operation field of the selected client. In the shown example, Person 4 has been assigned to work with Client 1 and Person 1-3 remain to be assigned. In this example, a client assignment requires a team of two people each at least having the competence profile as indicated in the minimum competence level fields 522, 524, 526, 528. It is also possible to assign the people to other tasks indicated in FIG. 5 in task fields as Task 1, Task 2 and Task 3. In the exemplifying embodiment, the tasks are research and development (R&D) projects for developing new tools and processes, Ad Hoc assignments including temporary jobs basically constituting simple assignments, and training including seminars, courses, internship and networking. A client assignment takes two periods to complete, which is indicated by period indicators 528 (also Cf. period indicator 308 in FIG. 3.

The R&D tasks gives a structure value indicated in points p, e.g. 0.5 p per competence level of a person calculated per period, to the cost of the salary of the assigned person. A competence value of e.g. 0.2 p is given per period and person. These values together with total structure value expressed in current points, e.g. 5.0 p and potential, e.g. 10.0 p are indicated in a retrievable R&D field (not shown). The retrievable fields are retrieved e.g. by means of cursor functionality. Similarly, the value of Ad Hoc tasks is further specified in a retrievable Ad Hoc field (not shown), wherein the cost which typically amounts to the salary and the money it pays, e.g. 1M per competence level of the persons are indicated. Again similarly, the values of the Training tasks are further specified in a retrievable Training field (not shown), wherein the cost which typically amounts to the salary and the competence value given by the training, e.g. 0.2 p per period and person provided they still have potential to improve.

Thus, with the aid of the described and similar visual input/output interfaces a number of decisions and new or updated parameter values are input to and presented by the simulation control unit. Thereafter, an updated status is calculated and distributed as described in connection with the inventive method disclosure.

The system components, the method steps and the visual interfaces are preferably realised, performed or carried out by means of specifically designed computer program units being operable to direct a data processing system to perform the functions and the steps of the invention.

The above description of embodiments is provided as examples of realisations of the invention, and of course other implementations and designs are conceivable within the inventive concept as set out in the accompanying claims.

1. A computer implemented simulation system for distributed simulation of a process, comprising:
a first simulator unit (115) having a simulation control unit (114) devised to control the simulation of a process of a simulation object operating with at least one resource entity according to a predetermined simulation scheme;
a user interface (116) communicatively coupled to the simulation control unit (114) devised for input and output of simulation parameter values between a human user and the simulation control units (114);
a simulation subject control unit (120) communicatively coupled to the simulation control unit (114) and devised to control an instance of a business entity dependent on said parameter values and predetermined rules for the simulation object;
a resource control unit (122) communicatively coupled to the simulation control unit (114) and devised to control a resource upon which the simulation subject operates on dependent on predetermined characteristics of said resource and on said parameter values; and
a decision handler (136) communicatively coupled to the simulation control unit (114) and devised to communicate updated parameter values between said first simulator unit and a second simulator unit participating in a simulation process.

2. The computer implemented simulation system as recited in claim 1, further comprising
a resource source control unit (126) communicatively coupled to the simulation control unit (114) and devised to control a simulated source of resources dependent on said parameter values and on said predetermined characteristics of the resources.

3. The computer implemented simulation system as recited in claim 1, further comprising
a resource entity control unit (122,124) communicatively coupled to the simulation control unit (114) and devised to control an instance of a resource entity dependent on predetermined characteristics of said resource entity and on said parameter values.

4. The computer implemented simulation system as recited in claim 1, further comprising
a simulation object control unit (130) communicatively coupled to the simulation control unit (114) and devised to control an instance of a simulation object entity on which the simulated subject operates dependent on predetermined characteristics of said simulation object entity and on said parameter values.

5. The computer implemented simulation system as recited in claim 1, further comprising
a simulation object entity control unit (132) communicatively coupled to the simulation control unit (114) and devised to control a simulated entity of a simulation object dependent on predetermined characteristics of said simulation object entity and on said parameter values.

6. The computer implemented simulation system as recited in claim 1, further comprising
a simulation object source control unit (134) communicatively coupled to the simulation control unit (114) and devised to control a simulated source of simulation object entities dependent on said parameter values and said predetermined characteristics of the simulation object entities.

7. The computer implemented simulation system as recited in claim 1, further comprising
a simulation scheme control unit (118) communicatively coupled to the simulation control unit (114) and devised to control the simulation process according to a predetermined scheme and to present to the user an act to be performed by the user at a current stage of the simulation process.

8. The computer implemented system as recited in claim 1, further comprising an automatic decision control unit (128) devised to simulate a team controlling an instance of a simulation subject at a second simulation unit and comprising predetermined rules for decisions and parameter updating.

9. The computer implemented system as recited in claim 8, wherein the automatic decision control unit (128) is devised to transmit decisions and/or parameter values to the simulation control unit (114) via the decision handler (136).

10. A computer implemented method for simulation of a process, in a system having a first and a second simulation unit being communicatively couplable, the method comprising the steps of:
at a first simulation unit, performing a first simulation phase including a first set of simulation steps based on a first current status dependent on a first set of simulation parameter values and thereby generating updated parameter values;
from said first simulation unit sending updated parameter values to said second simulation server;
at said first simulation unit, receiving parameter values updated by the second simulation unit;
at said first simulation unit, calculating a second current status dependent on said updated parameter values;
at said first simulation unit, performing a second simulation phase including a second set of simulation sets based on said second current status dependent on said updated parameter values.

11. The computer implemented method as recited in claim 10, further comprising the steps of:
from each said first and second simulation unit sending updated parameter values to the simulation server via the data communications network;
from the simulation server, sending parameter values updated by the first simulation unit to the second simulation unit, and parameter values updated by the second simulation unit to the first simulation unit.

12. The computer implemented method as recited in claim 10, further comprising the steps of:
establishing instances of simulation objects.

13. The computer implemented method as recited in claim 10, further comprising the steps of:
retrieving start parameters and start information from a database.

14. The computer implemented method as recited in claim 10, farther comprising the steps of:
establishing a start status of simulation entities and of a simulation situation dependent on predetermined parameter values.

15. The computer implemented method as recited in claim 10, further comprising the steps of:
receiving decision information and updated parameter values from users preferably via a visual input/output interface.

16. The computer implemented method as recited in claim 10, further comprising the steps of:
calculating and updating status dependent on decision information and parameter values.

17. The computer implemented method as recited in claim 10, further comprising the steps of:
automatically simulating user decisions and parameter updating.

18. The computer implemented method as recited in claim 10, further comprising the steps of:
initiating and maintaining a first and a second simulation unit being communicatively couplable in a data communications network.

19. A computer program product for use in a computer system for simulation of a process, the computer program product comprising:
means for directing the computer system to initiate and maintain a first and a second simulation unit being communicatively couplable in a data communications network;
means, at the first simulation units, for directing the computer system to perform a first simulation phase including a first set of simulation steps based on a first current status dependent on a first set of simulation parameter values and thereby generating updated parameter values;
means, at said first simulation unit, for directing the computer system to send updated parameter values to said second simulation server;
means, at said first simulation unit, for directing the computer system to receive parameter values updated by the second simulation unit;
means for directing the computer system to calculate a second current status dependent on said updated parameter values;
means for directing the computer system to perform at the first and second simulation units, a second simulation phase including a second set of simulation sets based on said second current status dependent on said updated parameter values.

20. A computer program product as recited in claim 19, further comprising:
means for directing the computer system to send, from each of said first and second simulation unit, updated parameter values to the simulation server via the data communications network;
means for directing the computer system to send, from the simulation server, parameter values updated by the first simulation unit to the second simulation unit, and parameter values updated by the second simulation unit to the first simulation unit.

21. A computer program product as recited in claim 19, further comprising means for directing the computer system to perform the method steps of claims 10-18.

22. A computer implemented simulation system for distributed simulation of a business process, comprising:
a simulation motor (204) devised to control the simulation of a business process comprising a business entity, a resource entity, a business object entity, a resource market and a business object market;
a user interface (202) communicatively coupled to the simulation control unit (204) for input and output of business parameters between human users and the simulation control unit (204);
a business subject entity control unit (210)communicatively coupled to the simulation control unit and devised to control an instance of a business entity dependent on the value of said business parameters;
a resource entity control unit (208) communicatively coupled to the simulation control unit (204) and devised to control an instance of a resource entity dependent on predetermined characteristics of said resource entity and on said business parameters;
a business object control unit (216) communicatively coupled to the simulation control unit (204) and devised to control an instance of a business object dependent on predetermined characteristics of said business object and on said business parameters;
a resource market control unit (212) communicatively coupled to the simulation control unit (204) and devised to control a simulated market of resources dependent on said business parameters and said predetermined characteristics of the resources and the business objects;
a business object market control unit (214) communicatively coupled to the simulation control unit (204) and devised to control a simulated market of business objects dependent on said business parameters and said predetermined characteristics of the resources and the business objects;
a decision handler (226) adapted to control the distribution of decisions and parameter updates to said simulation control unit or other simulation control units participating in a simulation process.

23. The computer implemented system as recited in claim 22, further comprising an asset control unit (220) communicatively coupled to each instance of said business entity control unit (210) and devised to control the consequences of business decisions and business parameters in terms of values.

24. The computer implemented system as recited in claim 23, further comprising an asset monitor control unit (222) communicatively coupled to the asset control unit (220) and devised to control the calculation and presentation of predetermined indicator parameters.

25. The computer implemented system as recited in claim 22, further comprising an automatic decision controller unit (224) communicatively coupled to a business entity control unit (210) and the decision handler (226), said automatic decision handler unit being devised to simulate a team controlling said business entity and comprising predetermined rules for decisions and parameter updating.

26. A computer implemented method for simulation a process, comprising steps for establishing and maintaining in a computer system the functional components of claims 1-9.

27. A computer program product for simulating a process, means for directing a computer system to establish and maintain the functional components of claims 1-9.

28. A computer implemented method for simulation a process, comprising steps for establishing and maintaining in a computer system the functional components of claims 22-25.

29. A computer program product for simulating a process, means for directing a computer system to perform the method steps of claims 22 to 24.
